(19) United States
(12) Patent Application Publication
(10) Pub. No.: US 2013/0252749 A1
(43) Pub. Date: Sep. 26, 2013

(54) PROPSHAFTS AND PROPSHAFT ASSEMBLIES AND METHODS FOR FABRICATING PROPSHAFTS

(71) Applicants: STEVEN W. CREEK, SHELBY TOWNSHIP, MI (US); EDRALIN S. DIAZ, TROY, MI (US); MICHAEL A. BRIDE, FARMINGTON HILLS, MI (US)

(72) Inventors: STEVEN W. CREEK, SHELBY TOWNSHIP, MI (US); EDRALIN S. DIAZ, TROY, MI (US); MICHAEL A. BRIDE, FARMINGTON HILLS, MI (US)

(73) Assignee: GM GLOBAL TECHNOLOGY OPERATIONS LLC, DETROIT, MI (US)

(21) Appl. No.: 13/426,060

(22) Filed: Mar. 21, 2012

(51) Int. Cl. F16C 3/02; B23P 11/00

(52) U.S. Cl. 464/181; 29/428

(57) ABSTRACT

Propshafts and propshaft assemblies for transferring torque in motor vehicles, and methods for fabricating such propshafts are provided. In one example, a propshaft comprises a fiber reinforced composite tube having a channel. The propshaft comprises a fiber reinforced composite tube and a splined female insert. The fiber reinforced composite tube has a channel and comprises a composite wall that is disposed around the channel. The splined female insert comprises a buried wall portion that is disposed in the channel operatively coupled to the composite wall. The buried wall portion has an inner surface and a plurality of internal splines formed along the inner surface.

### TECHNICAL FIELD

The present invention relates generally to propshafts, propshaft assemblies, and methods for fabricating propshafts, and more particularly to fiber reinforced composite propshafts for transferring torque in a motor vehicle, propshaft assemblies that include such propshafts, and methods for fabricating such propshafts.

### BACKGROUND

Motorized vehicles traditionally include a propeller shaft, i.e., propshaft, for transmitting an output torque from a transmission or transfer case through a differential to the wheels of the vehicle. For example, a transmission receives a drive torque from an internal combustion engine and employs gear ratios to modify the input torque to obtain various desired output torques. The output torque is then transmitted, e.g., directly from the transmission or indirectly from a transfer case, through a propshaft assembly to a front or rear differential unit, which evenly distributes the torque between a pair of axle shafts. The axle shafts, in turn, cause movement of the vehicle through the vehicle wheels.

During operation, propshaft assemblies are subjected to significant torsion and shear stresses and must be strong enough to bear these stresses. These assemblies, however, need to avoid too much weight that would otherwise substantially increase their inertia. Fiber reinforced composite propshafts offer significant weight savings over propshafts made from more traditional materials, such as metals, without decreasing the mechanical properties of the propshafts. The reduction in mass has a direct impact on the force required to accelerate and decelerate the vehicle. Due to the relatively low density and high mechanical properties of fiber reinforced composite propshafts, the moment of inertia (e.g. measure of the rotational inertia of the part) is significantly less than steel propshafts, thereby improving the overall vehicle performance.

Propshaft assemblies often include a shaft body having universal joints coupled at both ends for transmitting rotational energy and torque along the shaft body, and an intermediate slip yoke assembly for allowing for some axial movement along the shaft body to facilitate assembly, manage build variation, and the like. Current slip yoke assemblies for fiber reinforced composite propshafts are relatively large and heavy so that they can handle the significant loads carried by propshafts. As such, fiber reinforced composite propshaft assemblies often require significant package space, which is often very limited, to accommodate a slip yoke assembly. Additionally, the significant weight of these slip yoke assemblies can diminish some or many of the benefits of using a fiber reinforced composite propshaft.

Accordingly, it is desirable to provide fiber reinforced composite propshafts for transferring torque in a motor vehicle that allow for some axial movement while reducing package space requirements and/or weight, propshaft assemblies that include such propshafts, and methods for fabricating such propshafts. Furthermore, other desirable features and characteristics of the present invention will become apparent from the subsequent detailed description and the appended claims, taken in conjunction with the accompanying drawings and this background.

### SUMMARY

Propshafts and propshaft assemblies for transferring torque in motor vehicles, and methods for fabricating such propshafts are provided herein. In accordance with an exemplary embodiment, a propshaft for transferring torque in a motor vehicle comprises a fiber reinforced composite tube having a channel and a splined female insert. The fiber reinforced composite tube comprises a composite wall that is disposed around the channel. The splined female insert comprises a buried wall portion that is disposed in the channel operatively coupled to the composite wall. The buried wall portion has an inner surface and a plurality of internal splines formed along the inner surface.

In accordance with another exemplary embodiment, a propshaft assembly for transferring torque in a motor vehicle comprises a first propshaft member and a second propshaft member. The first propshaft member comprises a fiber reinforced composite tube and a splined female insert. The fiber reinforced composite tube has a channel and comprises a composite wall that is disposed around the channel. The splined female insert comprises a buried wall portion that is disposed in the channel operatively coupled to the composite wall. The buried wall portion has an inner surface and a plurality of internal splines formed along the inner surface. The second propshaft member comprises a male yoke. The male yoke has external splines that are engaged with the internal splines of the buried wall portion to allow telescopic movement between the male yoke and the splined female insert.

In accordance with another exemplary embodiment, a method for fabricating a propshaft for transferring torque in a motor vehicle is provided. The method comprises the steps of providing a fiber reinforced composite tube. The fiber reinforced composite tube comprises a composite wall that is disposed around a channel. A splined female insert is positioned into the fiber reinforced composite tube such that a buried wall portion of the splined female insert is positioned in the channel operatively coupled to the composite wall. The buried wall portion has a plurality of internal splines formed along an inner surface of the buried wall portion.

### DESCRIPTION OF THE DRAWINGS

The present invention will hereinafter be described in conjunction with the following drawing figures, wherein like numerals denote like elements, and wherein:

FIG. 1 is a perspective cut-away view of a propshaft assembly in accordance with an exemplary embodiment;

FIG. 2 is a partial perspective view of a fiber reinforced composite tube in accordance with an exemplary embodiment;

FIG. 3 is a perspective view of a splined female insert in accordance with an exemplary embodiment;

FIG. 4 is a partial perspective view of the fiber reinforced composite tube of FIG. 2 assembled with the splined female insert of FIG. 3 in accordance with an exemplary embodiment;

FIG. 5 is a partial perspective cut-away view of a propshaft assembly in accordance with an exemplary embodiment; and

FIG. 6 is a flowchart of a method for fabricating a propshaft for transferring torque in a motor vehicle in accordance with an exemplary embodiment.

### DETAILED DESCRIPTION

The following Detailed Description is merely exemplary in nature and is not intended to limit the invention or the application and uses of the invention. Furthermore, there is no intention to be bound by any theory presented in the preceding background or the following detailed description.

Various embodiments contemplated herein relate to fiber reinforced composite propshafts for transferring torque in a motor vehicle, propshaft assemblies that include such propshafts, and methods for fabricating such propshafts. Unlike the prior art, the exemplary embodiments taught herein provide a propshaft that comprises a fiber reinforced composite tube that includes a composite wall disposed around a channel. A splined female insert is arranged in the channel of the fiber reinforced composite tube. A wall portion of the splined female insert that is buried or positioned in the channel is operatively coupled to the fiber reinforced composite tube along the composite wall so that the splined female insert rotates together with the fiber reinforced composite tube to transfer torque in the motor vehicle.

In an exemplary embodiment, a plurality of internal splines is formed along an inner surface of the buried wall portion of the splined female insert. A male yoke that has external splines is operatively coupled with the splined female insert along the buried wall portion that is positioned in the channel to form an axial slip connection. In particular, the external splines of the male yoke are rotationally engaged with the internal splines of the splined female insert for transmitting rotational energy and torque while allowing for some telescopic movement, e.g., axial movement, between the male yoke and the splined female insert.

By positioning at least a portion of the axial slip connection formed by the male yoke and the splined female insert in the channel of the fiber reinforced composite tube, the package space requirements and weight for the propshaft can be reduced. In particular, the male yoke and the splined female insert are at least partially packaged in the internal channel space of the fiber reinforced composite tube and therefore, less package space is required outside of the fiber reinforced composite tube for packaging the axial slip connection. Additionally, the size and/or thickness of the splined female insert can be significantly reduced because the buried wall portion of the splined female insert is surrounded and structurally supported by the composite wall of the fiber reinforced composite tube. In particular, the composite wall is made from a relatively high strength fiber reinforced composite material, such as, for example, a resin matrix reinforced with carbon fibers and/or the like. The high strength fiber reinforced composite material, which is operatively coupled to the splined female insert, reinforces the splined female insert so that the splined female insert can be made with less structure, e.g., relatively thin and/or with less material, while still being strong enough to bear the significant loads carried by the propshaft. As such, the splined female insert can be made relatively light so that the axial slip connection including the splined female insert in combination with the male yoke weighs less than conventional slip yoke assemblies for propshafts.

Referring to FIG. 1, a perspective cut-away view of a propshaft assembly 10 in accordance with an exemplary embodiment is provided. Exemplary embodiments of the propshaft assembly 10 are for transferring torque in a motor vehicle and comprise a first propshaft member 12 and a second propshaft member 14. The first propshaft member 12 is configured as a fiber reinforced composite propshaft and comprises a fiber reinforced composite tube 16 that is operatively coupled to a splined female insert 18 and an end yoke 20. The second propshaft number 14 comprises a shaft body 22 that is operatively coupled to a male yoke 24 and an end yoke 26. As illustrated, the end yokes 20 and 26 are configured as universal joints for allowing some rotational movement as is well known in the art.

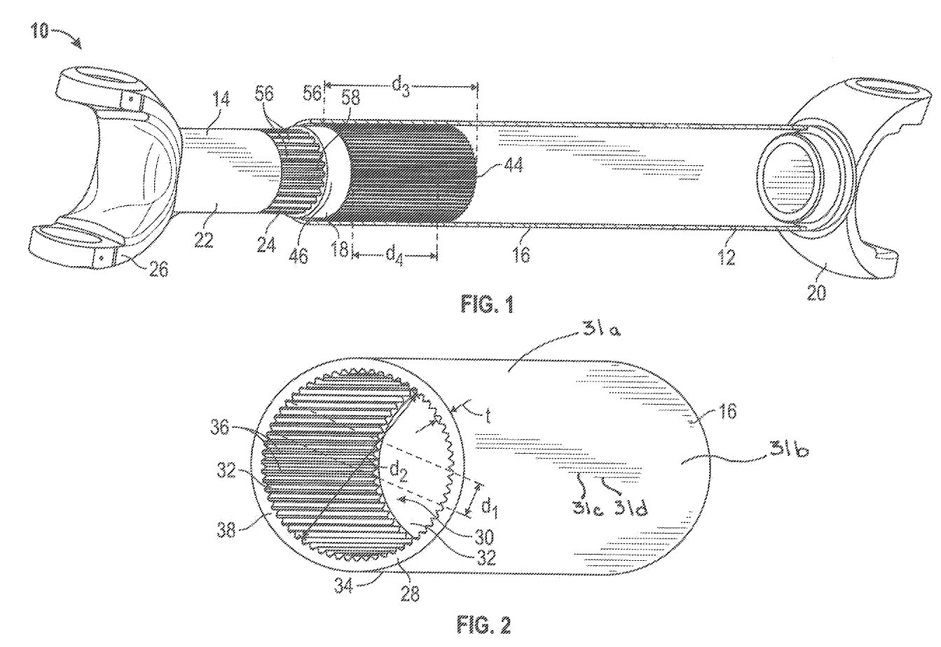

Referring to FIG. 2, a partial perspective view of the fiber reinforced composite tube 16 in accordance with an exemplary embodiment is provided. The fiber reinforced composite tube 16 is configured as a shaft body and comprises a composite wall 28 that is disposed around a channel 30. The composite wall 28 is formed of a fiber reinforced composite material that comprises a resin, such as an epoxy resin or the like, that is reinforced with fibers, such as carbon fibers, glass fibers, or the like. The reinforcing fibers, for example, may be wound at various angles and impregnation with the resin that is subsequently cured to form the fiber reinforced composite tube 16 as is well known in the art. Fiber reinforced composite tubes for propshafts are commercially available from a number of companies including Toray Industries, Inc., headquartered in Tokyo, Japan.

The fiber reinforced composite tube 16 has a first axial end portion 34 that has a plurality of groove 36 formed along an internal surface 32 of the composite wall 28. In an exemplary embodiment, the grooves 36 extend longitudinally along the internal surface 32 a distance (indicated by double headed arrow “d1”) from an outer-most end 38 of at least about 50 mm, for example of from about 50 to about 100 mm. In one exemplary embodiment, the fiber reinforced composite tube 16 has an internal diameter (indicated by double headed arrow “d2”) of from about 20 to about 25 mm, and a wall stock thickness (indicated by single headed arrows “t”) of from about 3 to about 5 mm.

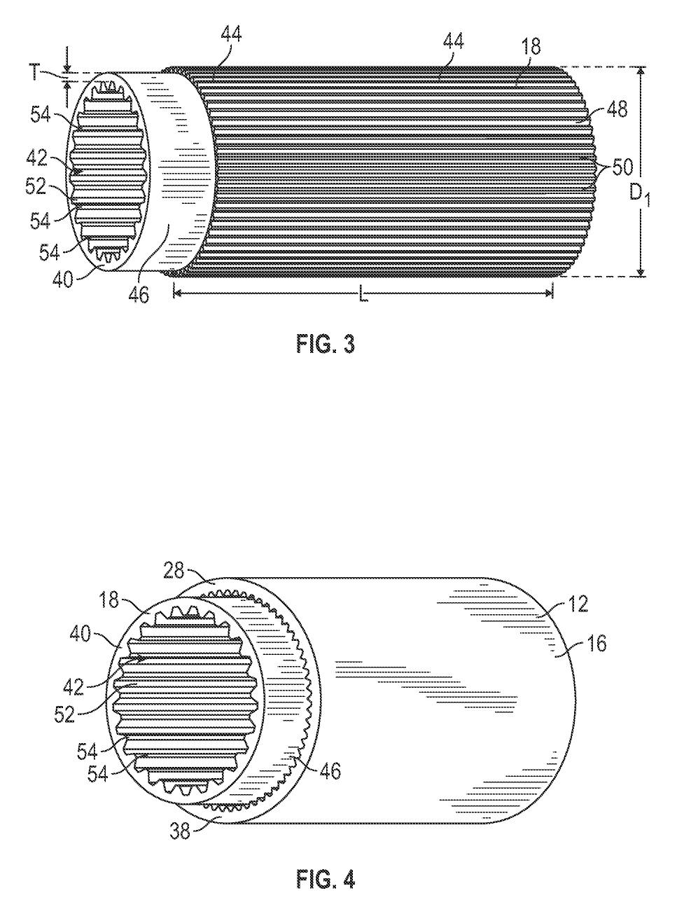

Referring to FIG. 3, a perspective view of the splined female insert 18 in accordance with an exemplary embodiment is provided. The splined female insert 18 may be formed of metal, such as by a metal drawing process or the like. As illustrated, the splined female insert 18 has a tubular configuration comprising a wall 40 that is disposed around a channel space 42. The wall 40 comprises a buried wall portion 44 (e.g. portion of the wall 40 that is inserted into (or buried in) the channel 30 of the fiber reinforced composite tube 16 when assembled) and an exposed wall portion 46 (e.g. portion of the wall 40 that is disposed outside of the channel 30 of the fiber reinforced composite tube 16 when assembled) that extends longitudinally from the buried wall portion 44. The buried wall portion 44 as an outer surface 48 and a plurality of external splines 50 formed longitudinally along the outer surface 48. In an exemplary embodiment, the external splines 50 are configured as fine splines having a height of about 1 mm or less, for example of from about 0.5 to about 1 mm, and a number of external splines 50 disposed along the outer surface 48 may be, for example, from about 50 to about 72. In one exemplary embodiment, the splined female insert 18 has an outer diameter (indicated by double headed arrow “D1”) of from about 20 to about 25 mm, and the wall 40 including the buried wall portion 44 has a thickness (indicated by single headed arrows “T”) of about 3 mm or less, for example of from about 2 to about 3 mm. In another exemplary embodiment, the buried wall portion 44 has a length (indicated by double headed arrow “L”) of at least about 50 mm, for example of from about 50 to about 100 mm.

Referring also to FIGS. 2 and 4, where like reference numbers refer to like components, the buried wall portion 44 of the splined female insert 18 is disposed in the channel 30 along the first axial end portion 34 of the fiber reinforced composite tube 16 and is operatively coupled to the composite wall 28. In an exemplary embodiment, the grooves 36 of the fiber reinforced composite tube 16 are matched and aligned with the external splines 50 to operatively couple the splined female insert 18 to the composite wall 28 for rotational energy and torque transfer.

As illustrated, the wall 40 of the splined female insert 18 has a plurality of internal splines 54 extending longitudinally along the inner surface 52 of the buried wall portion 44 and optionally the exposed wall portion 46. In an exemplary embodiment, the internal splines 54 formed along the exposed wall portion 46 extend into the buried wall portion 44, and thus, extend longitudinally into the channel of the fiber reinforced composite tube 16 a distance (indicated by double headed arrow “d3” in FIG. 1) of at least about 50 mm, for example of from about 50 to about 100 mm when assembled. In one exemplary embodiment, a number of internal splines 54 disposed along the inner surface 52 is from about 17 to about 32, for example of from about 25 to about 32.

Referring to FIGS. 1 and 4, the second propshafts member 14 has a plurality of external splines 56 formed longitudinally along an outer surface 58 of the male yoke 24. The male yoke 24 is disposed in the channel space 42 of the splined female insert 18 such that the external splines 56 are engaged with the internal splines 54 of the splined female insert 18 providing common rotational motion while allowing for some relative axial movement between the male yoke 24 and the splined female insert 18. As such, telescopic movement can occur between the male yoke 24 and the splined female insert 18 to define an axial slip connection between the first and second propshafts members 12 and 14. In an exemplary embodiment, the external splines 56 of the male yoke 24 extend into the channel space 42 of the splined female insert 18 along the buried wall portion 44 a distance (indicated by double headed arrow “d4”) of at least about 30 mm, for example of from about 50 to about 75 mm.

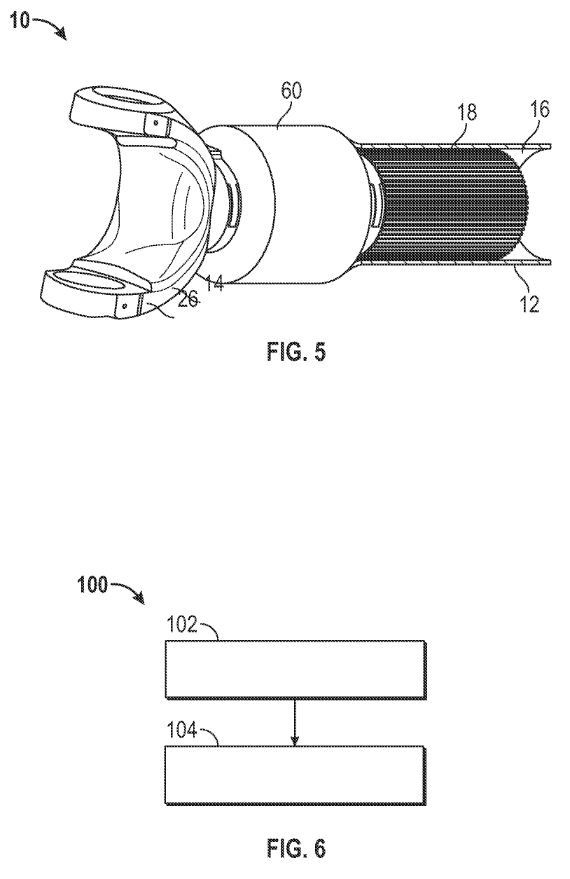

Referring to FIG. 5, a partial perspective cut-away view of a propshaft assembly in accordance with an exemplary embodiment is provided. The propshaft assembly 10 further comprises a boot 60. The boot 60 is disposed around the exposed wall portion 46 of the first propshaft member 12 and the shaft body 22 of the second propshafts member 14 to provide a protective covering for the internal splines 54 and the external splines 56 from outside elements, such as water, dirt, and the like. The boot 60 may be flexible to allow for relative axial movement between the first and second propshafts members 12 and 14 and can be formed, for example, from an elastomeric material.

Referring to FIG. 6, a flowchart of a method 100 for fabricating a propshaft for transferring torque in a motor vehicle in accordance with an exemplary embodiment is provided. The method 100 comprises providing a fiber reinforced composite tube (step 102) that comprises a composite wall disposed around a channel. A splined female insert is positioned into the fiber reinforced composite tube (step 104) such that a buried wall portion of the splined female insert is positioned in the channel operatively coupled to the composite wall. In an exemplary embodiment, the splined female insert is advanced into the channel using a push-fitting process. The buried wall portion has a plurality of internal splines formed along an inner surface of the buried wall portion.

Accordingly, fiber reinforced composite propshafts for transferring torque in a motor vehicle, propshaft assemblies that include such propshafts, and methods for fabricating such propshafts. Unlike the prior art, the exemplary embodiments taught herein provide a propshaft that comprises a fiber reinforced composite tube that includes a composite wall disposed around a channel. A splined female insert is arranged in the channel of the fiber reinforced composite tube. A wall portion of the splined female insert that is buried or positioned in the channel is operatively coupled to the fiber reinforced composite tube along the composite wall. A plurality of internal splines is formed along an inner surface of the buried wall portion of the splined female insert. A male yoke that has external splines is operatively coupled with the splined female insert along the buried wall portion in the channel to form an axial slip connection. By positioning at least a portion of the axial slip connection in the channel of the fiber reinforced composite tube, the package space requirements and weight for the propshaft can be reduced.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

1. A propshaft for transferring torque in a motor vehicle, the propshaft comprising:
a fiber reinforced composite tube having a channel and comprising a composite wall disposed around the channel; and
a splined female insert comprising a buried wall portion that is disposed in the channel operatively coupled to the composite wall, wherein the buried wall portion has an inner surface and a plurality of internal splines formed along the inner surface.

2. The propshaft of claim 1, wherein the fiber reinforced composite tube comprises carbon fibers.

3. The propshaft of claim 1, wherein the splined female insert is formed of metal.

4. The propshaft of claim 1, wherein the splined female insert is configured to receive a male yoke having external splines engagable with the internal splines of the buried wall portion to allow telescopic movement between the male yoke and the splined female insert.

5. The propshaft of claim 1, wherein the buried wall portion has an outer surface and a plurality of external splines formed along the outer surface to operatively couple the splined female insert to the composite wall.

6. The propshaft of claim 5, wherein the composite wall has an internal surface and a plurality of grooves formed along the internal surface, wherein the grooves are matched and aligned with the external splines to operatively couple the splined female insert to the composite wall.

7. The propshaft of claim 1, wherein the internal splines formed along the buried wall portion extend into the channel a distance of at least about 50 mm.

8. The propshaft of claim 1, wherein the internal splines formed along the buried wall portion extend into the channel a distance of from about 50 to about 100 mm.

9. The propshaft of claim 1, wherein the buried wall portion of the splined female insert has a thickness of about 3 mm or less.

10. The propshaft of claim 1, wherein the buried wall portion of the splined female insert has a thickness of from about 2 to about 3 mm.

11. The propshaft of claim 1, wherein the composite wall of the fiber reinforced composite tube has a thickness of from about 3 to about 5 mm.

12. The propshaft of claim 1, wherein the fiber reinforced composite tube has a first axial end portion and a second axial end portion opposite the first axial end portion, wherein the splined female insert is operatively coupled to the first axial end portion, and wherein the propshaft further comprises a yoke operatively coupled to the second axial end portion.

13. A propshaft assembly for transferring torque in a motor vehicle, the propshaft assembly comprising:
a first propshaft member comprising:
a fiber reinforced composite tube having a channel and comprising a composite wall disposed around the channel; and
a splined female insert comprising a buried wall portion that is disposed in the channel operatively coupled to the composite wall, wherein the buried wall portion has an inner surface and a plurality of internal splines formed along the inner surface; and
a second propshaft member comprising:
a male yoke having external splines engaged with the internal splines of the buried wall portion to allow telescopic movement between the male yoke and the splined female insert.

14. The propshaft assembly of claim 13, wherein the second propshaft member further comprises:
a shaft body operatively coupled to the male yoke.

15. The propshaft assembly of claim 13, wherein the splined female insert further comprises an exposed wall portion that extends axially from the buried wall portion and that is disposed adjacent to the fiber reinforced composite tube outside of the channel.

16. The propshaft assembly of claim 15, further comprising a boot that is disposed around the exposed wall portion of the splined female insert and at least a portion of the male yoke.

17. The propshaft assembly of claim 13, wherein the internal splines formed along the buried wall portion extend into the channel a first distance of at least about 50 mm and the external splines of the male yoke extend into the channel a second distance of at least about 30 mm.

18. The propshaft assembly of claim 13, wherein the internal splines formed along the buried wall portion extend into the channel a first distance of from about 50 to about 100 mm and the external splines of the male yoke extend into the channel a second distance of from about 50 to about 75 mm.

19. A method for fabricating a propshaft for transferring torque in a motor vehicle, the method comprising the steps of:
providing a fiber reinforced composite tube that comprises a composite wall disposed around a channel; and
positioning a splined female insert into the fiber reinforced composite tube such that a buried wall portion of the splined female insert is positioned in the channel operatively coupled to the composite wall, wherein the buried wall portion has a plurality of internal splines formed along an inner surface of the buried wall portion.

20. The method of claim 19, wherein the step of positioning comprises advancing the internal splines formed along the buried wall portion into the channel a distance of at least about 50 mm.
